(19) United States
(12) Patent Application Publication
(10) Pub. No.: US 2005/0228875 A1
(43) Pub. Date: Oct. 13, 2005

(54) System for estimating processing requirements

(76) Inventors: Arnold Monitzer, Pullach im Isartal (DE); Bhanu Gouda, Exton, PA (US)

Correspondence Address: Alexander J. Burke;Intellectual Property Department, 5th Floor, 170 Wood Avenue South, Iselin, NJ, 08830, US

(21) Appl. No.: 10/897,924

(22) Filed: Jul. 23, 2004

Related U.S. Application Data
(60) Provisional application No. 60/561,922, filed on Apr. 13, 2004.

(51) Int. Cl. G06F 15/177; G06F 15/173

(52) U.S. Cl. 709/221; 709/224

(57) ABSTRACT

An application estimates sizing information and capacity limits for a processing system configuration using load data automatically provided by a load determination application. A system supports selection of processing devices for a particular user. At least one repository includes, usage information indicating distribution of usage of a plurality of functions supported by a particular configuration of processing devices and capacity information including data identifying a load limit associated with a particular usage distribution and a particular configuration of processing devices. An interface processor retrieves, from the at least one repository, data identifying a candidate particular configuration of processing devices in response to received data indicating a particular usage distribution.

This is a non-provisional application of provisional application Ser. No. 60/561,922 by A. Monitzer et al. filed Apr. 13, 2004.

### FIELD OF THE INVENTION

This invention concerns a system and user interface for use in selecting a configuration of processing devices for a particular use and for acquiring capacity information for a processing device configuration.

### BACKGROUND INFORMATION

A number of problems exist in providing a computer processing system appropriate for a particular use or user. A computer processing system may include a network of one or more PCs and Servers executing applications, including WEB based applications, for example. Existing systems size a processing system for a particular use by employing manual error prone processes to derive a hardware and software configuration. Further, existing sizing systems employ load test tools to validate that system performance (e.g. response times, throughput, etc.) are within specified requirements. A maximum capacity limit threshold of individual hardware components of a system is determined and a specific hardware implementation is sized based on these individual hardware component limit thresholds to fulfill a required system performance. The capacity limits are typically specific to a particular version of a sizing tool used by technical sales personnel to provide hardware for a specific customer (characterized by customer statistics).

One problem results from inconsistency that occurs between versions of a sizing tool distributed to geographically dispersed technical sales personnel. This results in discrepancies and non-optimal sizing estimation of processing system requirements. Further, existing estimation systems involved in processing system configuration sizing, performance analysis and pricing, lack accuracy, automation and adaptability. Existing tools also typically provide individual functions that are not comprehensive, lack integration and employ error prone manual processes for determining computer processing system capacity limits. The distribution of a current version of a sizing tool to a worldwide sales organization is also often a lengthy burdensome process. A system according to invention principles addresses these deficiencies and related deficiencies.

### SUMMARY OF THE INVENTION

A centrally accessed automated adaptive system is integrated with load test and load generation applications and improves the accuracy of processing system estimation, related analysis functions and pricing. A system supports selection of processing devices for a particular user and incorporates at least one repository including, usage information indicating distribution of usage of a plurality of functions supported by a particular configuration of processing devices and capacity information including data identifying a load limit associated with a particular usage distribution and a particular configuration of processing devices. An interface processor retrieves, from the at least one repository, data identifying a candidate particular configuration of processing devices in response to received data indicating a particular usage distribution.

### BRIEF DESCRIPTION OF THE DRAWING

FIG. 1 shows a loading system for determining the behavior of a processing system over a user load profile, according to invention principles.

FIG. 2 shows two examples of user load profiles employable by the load system of FIG. 1, according to invention principles.

FIG. 3 shows a process of increasing a load in the system of FIG. 1 until predetermined performance requirements are no longer satisfied, according to invention principles.

FIG. 4 shows a load capacity limit table automatically generated by a particular version of a processing configuration estimation application for a specific user load profile, according to invention principles.

FIG. 5 shows a structure of a processing device configuration estimation application and load capacity determination system, according to invention principles.

FIG. 6 shows an image window enabling user entry of processing configuration requirements, according to invention principles.

FIG. 7 shows pricing information of an estimated processing configuration, according to invention principles.

FIG. 8 shows a flowchart of a process employed by the system of FIG. 1 for performing a load capacity limit test, according to invention principles.

FIG. 9 shows a flowchart of a process for determining a capacity load limit threshold, according to invention principles.

FIG. 10 shows a flowchart of a process for selecting processing devices and acquiring capacity information for a particular configuration of processing devices for a particular user, according to invention principles.

### DETAILED DESCRIPTION OF INVENTION

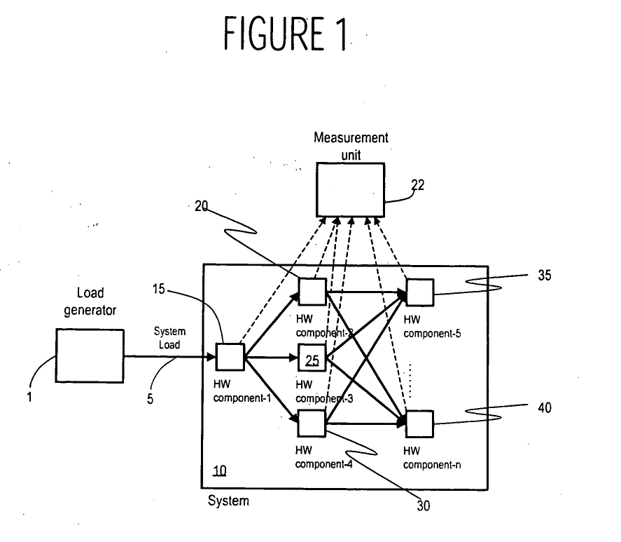

FIG. 1 shows a loading system for determining the behavior of a computer processing system over a user load profile. The system information and capacity limits are exported from a load test application and imported by a processing device configuration estimation application. The estimation application stores information required to estimate configurations based on user statistics and keeps track of processing device configuration bids created by sales personnel. The system analyzes stored sales data to determine data for use in refining estimation operation. User specific load profile data is automatically provided to a loading system. A centrally accessed automated adaptive system is used to estimate a processing device configuration for use in supporting particular functions and executable applications. The system employs load test and load generation applications and improves the accuracy of processing device estimation, related analysis functions and pricing. Determined load capacity limits are automatically provided to the processing configuration estimation executable application. The processing configuration estimation application is advantageously centrally accessible via the Internet enabling sales or technical support personnel access to a single current version of the application.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

FIG. 1 shows load generator 1 which is used to initiate selected system functions to exercise system throughput (such as routing) or system response (such as transaction-response), for example, in order to determine system behavior over a system load range. Load generator 1 applies a certain load 5 to processing device configuration 10. Load 5 may represent a certain user community or a certain client system connected to processing device configuration 10. Unit 10 appears to be a black box from the perspective of load generator 1 and measurement unit 22 measures unit 10 response or system throughput. Processing device configuration 10 provides different functions visible to an external user (represented by load generator 1) and these may be selectively exercised by load generator 1 depending on the desired level of analytical detail of performance of unit 10. Execution of specific functions of unit 10 may involve one or more hardware (HW) components of unit 10.

In exemplary operation, load generator 1 exercises a first set and a different second set of functions of unit 10. The first set of functions involves exercise of hardware components 15, 20, and 35 and the second set of functions involves exercise of hardware components 15, 25, 30, and 40. Similarly, different user behavior may be simulated by exercising different functions comprising different combinations of components. User behavior may be advantageously described by the frequency of usage for specific system functions.

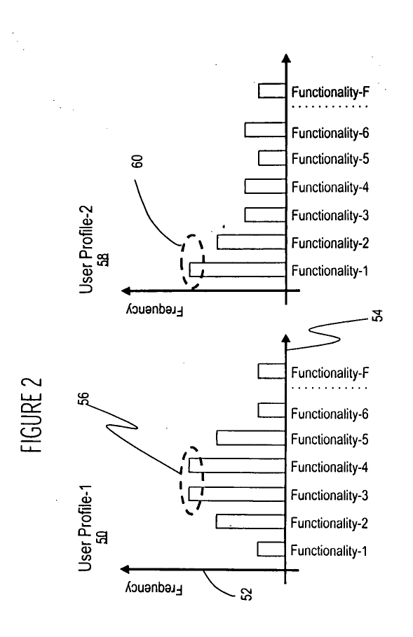

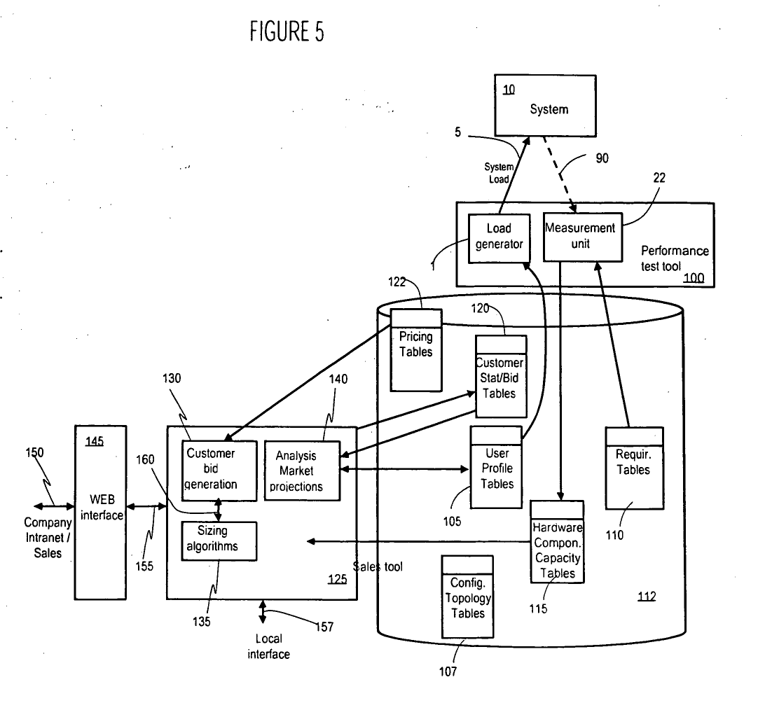

FIG. 2 shows two examples of user load profiles (user profile-1 (50) and user profile-2 (58)) employable by the load system of FIG. 1. Different HW components of configuration 10 are required for user profile-1 (50) and user profile-2 (58), since functions are employed with different usage frequencies by different users. Specifically, in user profile-1 (50) functionality-3 and functionality-4 (item 56) are most commonly employed and in user profile-2 (58) functionality-1 (item 60) is most commonly employed. Processing device configuration 10 in FIG. 1 employs components (15, 20, 25, 30, 35 and 40) that are sized differently for user profile-1 (50) than for user profile-2 (58). A user profile table (item 105 shown in FIG. 5 discussed later) advantageously stores a characteristic frequency of functions employed by particular users. This information may be stored in a table where column data represents functions and row data represents different user profiles, for example. The values in the table reflect the frequency for a specific function and a specific user profile. Load generator 1 is configured automatically to reflect the user profile during a load test to determine load capacity limits.

FIG. 5 shows a structure of a processing configuration estimation application that uses load capacity limits of individual hardware components determined non-intrusively by measuring unit 22 through a load test for a specific user profile. Measurement unit 22 tracks performance (90) of individual hardware components such as utilization (CPU, memory) and responsiveness (throughput, response times) during a load test. A specific version of processing configuration estimation application 125 acquires load capacity information from hardware component capacity tables 115 and provides analysis and data export capability used to maintain user profile tables 105.

FIG. 5 illustrates integration of processing configuration estimation application 125 with load capacity determination application 100 and database 112. Database 112 may comprise a single repository or multiple distributed databases. User profile data may be stored within processing configuration estimation application 125 or performance test tool 100 instead of individual repository 112, for example. In such a distributed database embodiment, application 125 ensures individual databases are synchronized and updated to ensure the databases contain the consistent current data. Application 125 also provides a WEB interface 145 for Intranet-wide access for technical sales personnel via communication channels 150 and 155, for example. It enables a user to access the latest and most accurate sizing information worldwide. In a load simulation, load generator 1 automatically linearly increases load (or alternatively increases load according to a non-linear function) for user profiles stored in user profile tables 105. Load generator 1 advantageously uses the profiles stored in user profile tables 105 to determine a set of load capacities for hardware components under test. Measurement unit 22 acquires a list of performance counters and load capacity limit thresholds for hardware components in a processing device configuration to be tested from requirements tables 110.

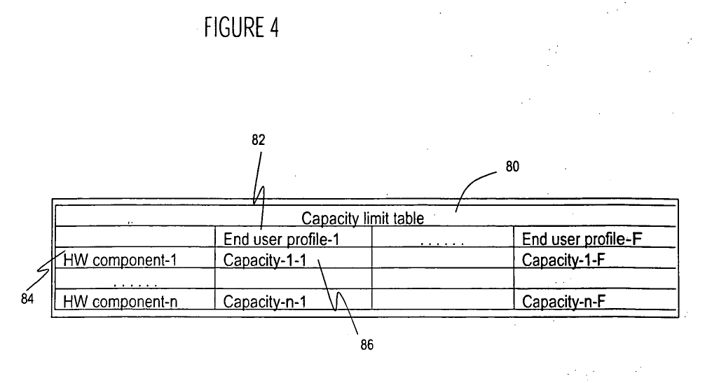

Measurement unit 22 compares actual performance counters of hardware components with load limit thresholds and creates a load capacity limit table 80 shown in FIG. 4 for the current hardware implementation and application 125 software version for the different user profiles tested. FIG. 4 shows a load capacity limit table 80 automatically generated by a particular version of processing configuration estimation application 125 for a specific user load profile. Load capacity limits are shown (e.g., 86) for individual hardware components 84 and different user profiles (e.g., 82). In another embodiment, table 80 includes records identifying different hardware implementation component attributes (e.g., different vendors or versions of a hardware component). In another embodiment, the load limit threshold results are stored in a temporary table of hardware component capacity tables 115 (FIG. 5) to be merged with a final result table after a load test has been determined to be valid. Measurement unit 22 also keeps track of network bandwidth requirements by conducting network-sniffing measurements to analyze bandwidth requirements. Tables (105, 110, 115, 120, 122) are stored in the database 112.

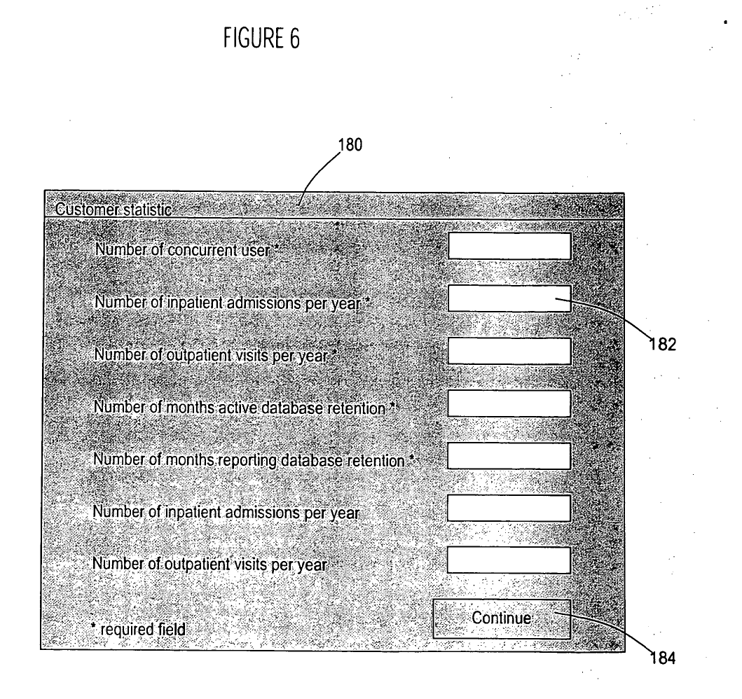

Processing configuration estimation application 125 provides an integrated WEB interface 145 via communication link 155. This enable worldwide access by web browsers via company intranet 150 supporting technical sales personnel or a local user interface 157. FIG. 6 shows an image window 180 enabling user entry of processing configuration requirements for a medical application. A sales person enters user specific statistics (e.g., 182) or user profile information via the FIG. 6 display image. A user selects continuation button 184 to initiate generation of subsequent images enabling entry of further user specific statistics. Sizing algorithm 135 (FIG. 5) acquires the latest capacity limits and hardware information from hardware component capacity tables 115 and topological information from configuration topology tables 107 in order to determine hardware component processing capacity (size) required for a specific user. Component processing capacity and other characteristics, determined for a user by estimation application 125, are stored in customer statistic/bid tables 120. Customer statistics and bid sheets are advantageously tracked in customer statistics and bid tables 120 and used by analysis processor 140 to generate customer profiles that are fed back into user profile tables 105. Sizing algorithm 135 extrapolates hardware component processing capacity requirements from existing measurement points, using for example, a linear extrapolation of memory requirements, a linear extrapolation of disk space requirements and a known queuing based extrapolation of processor speed requirements. Such a known queuing extrapolation involves an algorithm processing factors including data packet arrival and service times, a number of servers involved, a number of buffers employed, a number of users and assumes first come first served handling such as a known M/M/I queuing extrapolation, for example.

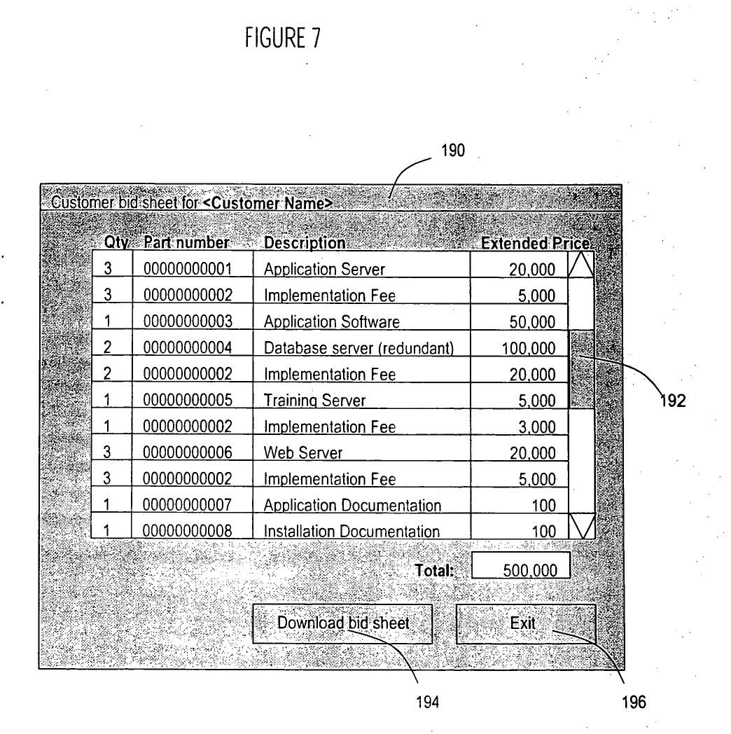

A sales person is able to print data indicating a required hardware processing device configuration without generating pricing or bid data for a user configuration. A user pricing or bid sheet is generated with the latest pricing information for an estimated processing device configuration in response to an entered command. Bid generation module 130 acquires pricing information from pricing tables 122 for hardware components recommended based on a processing device configuration estimated using sizing algorithm 135 and prepares a detailed itemized bill of material with part numbers and list prices for a user. FIG. 7 shows pricing information of an estimated processing configuration in the form of an itemized bid sheet 190. The itemized bid sheet may be downloaded as a document to a local computer via button 194 and scrolled via scroll element 192. A user exits the FIG. 7 menu via button 196.

Market projection analyzer 140 analyzes customer information stored in customer statistic/bid tables 120 to detect new customer profiles for storage in user profile tables 105 for consideration during a subsequent processing device configuration load test. Load capacity threshold limits of individual hardware components are determined during a linearly increasing load test involving incrementing a load at periodic time intervals, for example. The process of increasing the load is continued until predetermined performance counters (requirements) are no longer satisfied.

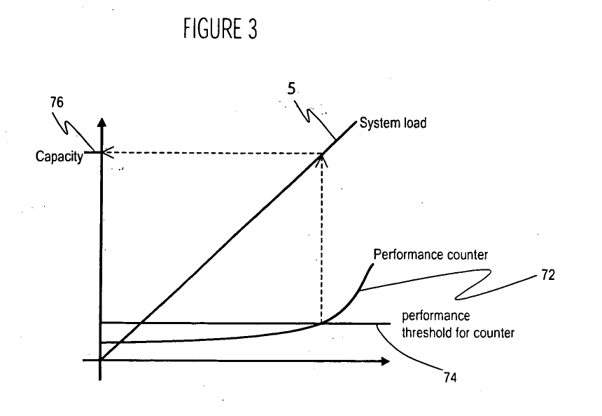

FIG. 3 shows a process of increasing a load until predetermined performance requirements are no longer satisfied as employed by the system of FIG. 1. Load 5 is linearly increased until a value of a performance counter 72 exceeds a predetermined threshold 74 (a predetermined user requirement). Multiple performance counters are monitored for an individual hardware component and concurrently compared to a requirement threshold. A load capacity limit threshold (capacity) 76 of an individual hardware component is determined in response to a first performance counter threshold being exceeded. The FIG. 3 graph illustrates that different capacity limits occur with different selections of equipment (hardware components) and different vendor options used for realization of an individual hardware component. Using the FIG. 1 system, a first load capacity limit threshold is determined for a hardware component from a first vendor and a second load capacity limit threshold is determined for a hardware component from a second vendor, for example.

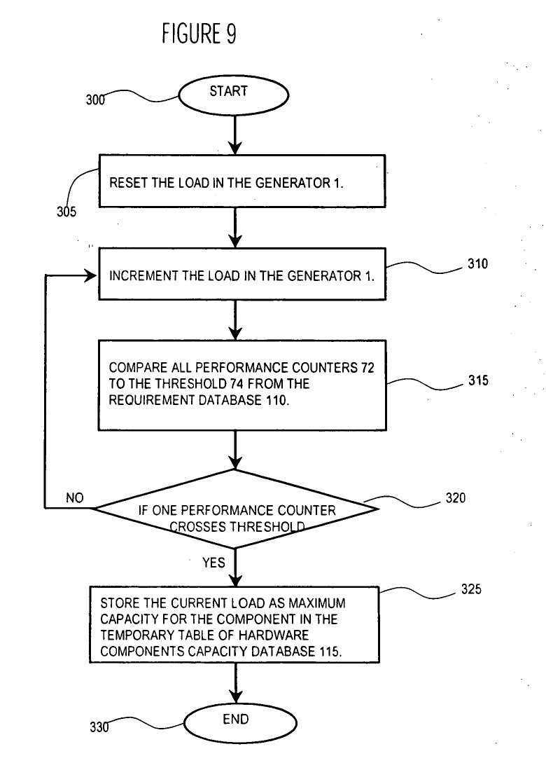

FIG. 9 shows a flowchart of a process (algorithm) used by the system of FIG. 1 to detect a load capacity limit threshold as illustrated in FIG. 3. Load generator 1 (FIG. 1) is reset in step 305 following the start at step 300. In step 310 load generator 1 increases load 5 on system 10 by an increment and in step 315 measurement unit 22 compares performance counters 72 (FIG. 3) with load capacity limit thresholds 74 acquired from database 110 (FIG. 5). Load generator 1 increments load 5 and unit 22 performs comparisons in iteratively executing steps 310-320 until it is determined in step 320 that a load capacity limit threshold is exceeded. In response to a threshold being exceeded, a current load value in step 325 is stored, as representing a maximum load capacity for a particular hardware component and user profile, in component capacity table 115 (FIG. 5). The process of FIG. 9 terminates at step 330.

Requirements tables 110 (FIG. 5) are employed by processing configuration estimation application 125 and include performance counters (e.g. system response time) and a load capacity limit threshold for a specific hardware component in the configuration (e.g. maximum guaranteed response time). Requirements tables 110 contain a list of performance counters and maximum acceptable load capacity limits for these counters. For example, for the system of FIG. 1 tables 110 includes a table for HW component 15, a table for HW component 20, and so on. The hardware component requirements are independent of particular component implementation. Hardware component capacity tables 115 include capacity results found during a load test. Measurement unit 22 advantageously associates a value of a performance counter with required acceptable load capacity limits derived from requirements tables 110.

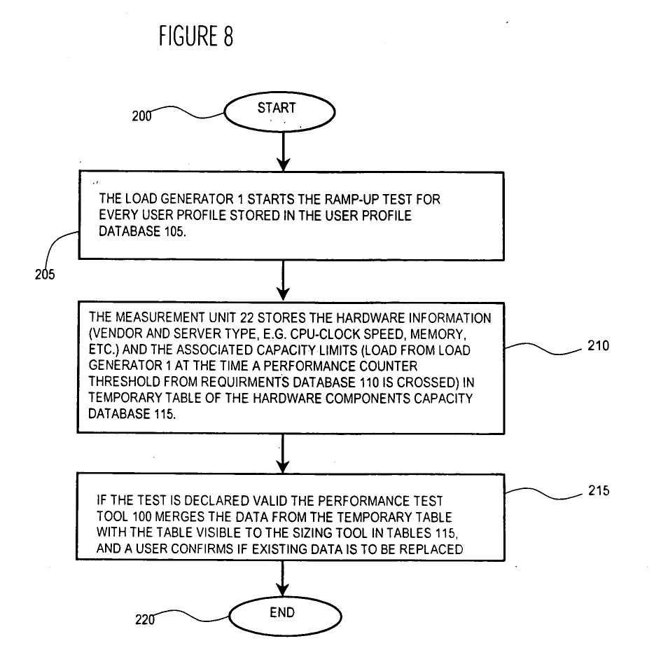

FIG. 8 shows a flowchart of a process employed by the system of FIG. 1 for performing a load capacity limit test. The process of FIG. 8 ensures valid performance results are transferred into database 115 (FIG. 5). Load generator 1 in step 205 following the start at step 200 linearly increases load on system 10 FIG. 1 for a particular user profile acquired from tables 105 (FIG. 5). In step 210, measurement unit 22 (FIG. 1) automatically detects load capacity limits of hardware components (15, 20, 25, 30, 35, 40) using performance requirement thresholds acquired from tables 110 that prescribe acceptable system behavior. Measurement unit 22 stores load capacity limits (load generated by generator 1 at a threshold when a performance threshold from database 110 is exceeded) and also stores associated data including hardware component information such as, vendor identifier, server type, CPU clock speed and memory utilization. This data is stored in a temporary table in hardware component capacity tables 115. In step 215, in response to a determination that a performed load capacity measurement test is valid, performance unit 100 (FIG. 5) automatically transfers load capacity limits and associated data from temporary tables in component capacity tables 115 to permanent tables within tables 115 accessible by processing configuration estimation application 125. A user is required to enter an acceptance confirmation command if the transfer replaces existing data in tables 115. The process of FIG. 8 ends at step 220.

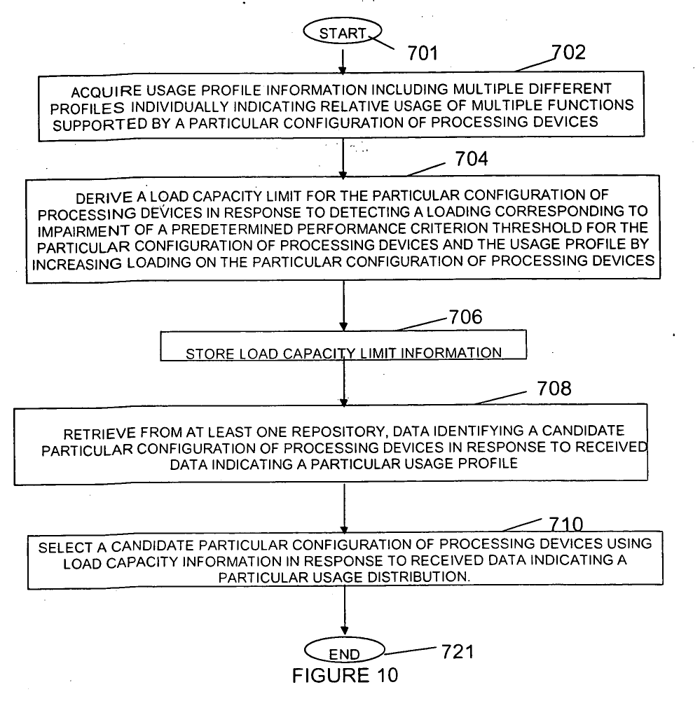

FIG. 10 shows a flowchart of a process for selecting processing devices and acquiring capacity information for a particular configuration of processing devices for a particular user. In step 702 following the start at step 701, repository 112 (specifically table 105 of FIG. 5) acquires usage profile information including multiple different profiles individually indicating relative usage of a multiple functions supported by a particular configuration of processing devices. A particular usage distribution indicates relative usage of multiple executable applications or multiple features of a particular executable application. Also a particular usage distribution may indicate relative usage as a proportion of a total usage or a percentage of a total usage. Performance unit 100 in step 704 acquires capacity information for the particular configuration of processing devices by deriving a capacity limit for the particular configuration of processing devices. This is done based on detecting a load limit corresponding to impairment of a predetermined performance criterion threshold resulting from increasing loading on the particular configuration of processing devices in accordance with the acquired usage distribution. A load limit may comprise a number of concurrent users, a number of users of a particular executable application, a number of users of a particular processing device, a bandwidth limitation, a signal latency duration, a CPU resource utilization and a system response time duration. A predetermined performance criterion threshold in other embodiments may also include a signal latency duration, a CPU resource utilization, a system response time duration or memory resource utilization. The acquired load capacity information is automatically received and stored in step 706 in tables 115 in repository 112.

In step 708 processing configuration estimation application 125 retrieves from at least one repository (e.g., repository 112) data for use in identifying a candidate particular configuration of processing devices in response to received data indicating a particular usage distribution. The data determining a candidate particular configuration of processing devices includes topology information in tables 107 of repository 112 indicating a network arrangement of processing devices of the particular configuration of processing devices. In step 710 application 125 selects a candidate particular configuration of processing devices (from multiple candidate configurations of processing devise) using acquired capacity information in response to received data indicating a particular usage distribution. Application 125 incorporates a price estimator function for use in deriving a bid price for a selected particular configuration of processing devices based on pricing information stored tables 122 of repository 112. The process of FIG. 10 terminates at step 721.

The system and processes presented in FIGS. 1-10 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system of FIGS. 1 and 5 may be implemented in hardware, software or a combination of both.

1. A system supporting selection of processing devices for a particular user, comprising:
at least one repository including,
usage information indicating distribution of usage of a plurality of functions supported by a particular configuration of processing devices and
capacity information including data identifying a load limit associated with a particular usage distribution and a particular configuration of processing devices; and
an interface processor for retrieving, from said at least one repository, data for use in identifying a candidate particular configuration of processing devices in response to received data indicating a particular usage distribution.

2. A system according to claim 1, including
a communication processor for automatically receiving said capacity information and storing said capacity information in said at least one repository.

3. A system according to claim 1, wherein
said interface processor retrieves, from said at least one repository, data identifying a candidate particular configuration of processing devices in response to received data indicating a load limit.

4. A system according to claim 3, wherein
said load limit comprises at least one of, (a) a number of concurrent users, (b) number of users of a particular executable application, (b) a number of users of a particular processing device, (c) a bandwidth limitation, (d) a signal latency duration, (e) a CPU resource utilization and (f) a system response time duration.

5. A system according to claim 1, wherein
a particular usage distribution indicates relative usage of, at least one of, (a) a plurality of executable applications and (b) a plurality of features of a particular executable application.

6. A system according to claim 1, wherein
a particular usage distribution indicates relative usage as at least one of, (a) a proportion of a total usage and (b) a percentage of a total usage

7. A system according to claim 1, wherein
said at least one repository includes
topology information indicating a network arrangement of said devices of said particular configuration of processing devices.

8. A system according to claim 1, wherein
said at least one repository includes performance information associated with said particular configuration of processing devices and
said capacity information is determined for said particular configuration of processing devices in response to said performance information.

9. A system according to claim 8, wherein
said performance information comprises at least one of, (a) a signal latency duration, (b) a CPU resource utilization, (c) a system response time duration and (d) memory resource utilization.

10. A system according to claim 1, including
a test unit for acquiring capacity information by,
selecting a particular configuration of processing devices,
selecting a particular usage distribution comprising a relative usage of a plurality of functions supported by said particular configuration of processing devices,
increasing loading on said particular configuration of processing devices consistent with said selected particular usage distribution and
deriving a capacity limit for said particular configuration of processing devices in response to detecting a loading corresponding to impairment of a predetermined performance criterion threshold.

11. A system according to claim 1, wherein
said at least one repository includes price data associated with said particular configuration of processing devices and including
a price estimator for using said price data for generating price information for said candidate particular configuration of processing devices.

12. A system for acquiring capacity information for a particular configuration of processing devices, comprising:
a user interface enabling a user to,
select a particular configuration of processing devices and
select a particular usage distribution comprising a relative usage of a plurality of functions supported by said particular configuration of processing devices;
a load unit for increasing loading on said particular configuration of processing devices and
a data analyzer for deriving a capacity limit for said particular configuration of processing devices in response to detecting a loading corresponding to impairment of a predetermined performance criterion threshold.

13. A system supporting selection of processing devices for a particular user, comprising:
at least one repository including,
usage profile information including a plurality of different profiles individually indicating relative usage of a plurality of functions supported by a particular configuration of processing devices and
capacity information including data identifying a load limit associated with a particular usage profile and a particular configuration of processing devices; and
an interface processor for identifying a candidate particular configuration of processing devices in response to received data indicating a usage profile.

14. A system according to claim 13, wherein
an individual usage profile indicates relative usage of, at least one of, (a) a plurality of executable applications and (b) a plurality of features of a particular executable application.

15. A system supporting selection of processing devices for a particular user, comprising:
at least one repository including,
usage information indicating distribution of usage of a plurality of functions supported by a particular configuration of processing devices,
performance information associated with a particular configuration of processing devices and
capacity information including data identifying a load limit associated with a particular usage distribution and a particular configuration of processing devices; and
a data processor for using said at least one repository determining said capacity information for a particular configuration of processing devices in response to detecting a loading corresponding to impairment of a predetermined performance criterion threshold.

16. A system according to claim 15, including
an interface processor for identifying a candidate particular configuration of processing devices in response to received data indicating a particular usage distribution.

17. A method for selecting processing devices for a particular user, comprising the activities of:
acquiring usage information indicating distribution of usage of a plurality of functions supported by a particular configuration of processing devices;
storing capacity information including data identifying a load limit associated with a particular usage distribution and a particular configuration of processing devices; and
selecting a candidate particular configuration of processing devices using said capacity information in response to received data indicating a particular usage distribution.

18. A method for acquiring capacity information for a particular configuration of processing devices, comprising the activities of:
initiating selection of a particular configuration of processing devices;
initiating selection of a particular usage distribution comprising a relative usage of a plurality of functions supported by said particular configuration of processing devices;
increasing loading on said particular configuration of processing devices compatible with said selected particular usage distribution; and
deriving a capacity limit for said particular configuration of processing devices in response to detecting a loading corresponding to impairment of a predetermined performance criterion threshold.

19. A method for selecting processing devices for a particular user, comprising the activities of:
acquiring usage profile information including a plurality of different profiles individually indicating relative usage of a plurality of functions supported by a particular configuration of processing devices and
acquiring capacity information including data identifying a load limit associated with a particular usage profile and a particular configuration of processing devices; and
identifying a candidate particular configuration of processing devices in response to received data indicating a particular usage profile.

20. A method for selecting processing devices for a particular user, comprising the activities of:
acquiring usage information indicating distribution of usage of a plurality of functions supported by a particular configuration of processing devices;
acquiring performance information associated with a particular configuration of processing devices;
acquiring load capacity information including data identifying a load limit associated with a particular usage distribution and a particular configuration of processing devices; and
determining said capacity information for a particular configuration of processing devices in response to detecting a loading corresponding to impairment of a predetermined performance criterion threshold.
